(19) United States
(12) Patent Application Publication
(10) Pub. No.: US 2007/0268692 A1
(43) Pub. Date: Nov. 22, 2007

(54) ILLUMINATION SYSTEM

(75) Inventors: Sung-Nan Chen, Hsinchu (TW); Li-Han Wu, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/688,418

(22) Filed: Mar. 20, 2007

(30) Foreign Application Priority Data
May 22, 2006 (TW) 95118065

(51) Int. Cl. F21V 9/00

(52) U.S. Cl. 362/231

(57) ABSTRACT

An illumination system including a light guide element and at least one light source device is provided. The light source device includes a first light combination module disposed near the light guide element and having a first filter film, a second light combination module having a second filter film, at least one first light source, at least one second light source and at least one third light source. There is a gap between the first and second light combination modules. A first light from the first light source is reflected to the light guide element by the first filter film, and a second light from the second light source and a third light from the third light source pass through the first filter film. The second light is reflected to the light guide element by the second filter film, and the third light passes through the second filter film.

### CROSS-REFERENCE TO RELATED APPLICATION

This application claims the priority benefit of Taiwan application serial no. 95118065, filed May 22, 2006. All disclosure of the Taiwan application is incorporated herein by reference.

### BACKGROUND OF THE INVENTION

1. Field of the Invention

The present invention relates to an illumination system, and more particularly, to an illumination system adaptable to a projection device.

2. Description of the Related Art

Referring to FIG. 1, a conventional illumination system 100 comprises an integration rod 110, two dichroic mirrors 120, 125 and a plurality of light emitting diode (LED) arrays 130, 140 and 150. The dichroic mirrors 120, 125 are disposed adjacent to a light incident surface 112 of the integration rod 110, and the dichroic mirror 120 is crossed with the dichroic mirror 125. The LED arrays 130, 140, 150 are disposed adjacent to the dichroic mirrors 120, 125. The LED array 150 is opposite to the light incident surface 112 of the integration rod 110, and the LED arrays 130, 140 are located at one opposite side of the dichroic mirror 120 respectively. In addition, the LED array 130 is suitable for providing a red light 132, the LED array 140 is suitable for providing a blue light 142 and the LED array 150 is suitable for providing a green light 152.

In view of the above, the red light 132 is reflected by the dichroic mirror 120, and the blue light 142 and the green light 152 pass through the dichroic mirror 120. The blue light 142 is reflected by the dichroic mirror 125, and the red light 132 and the green light 152 pass through the dichroic mirror 125. Thus, the red light 132, blue light 142 and green light 152 provided by the LED arrays 130, 140, 150 are blended into a white light within the integration rod 110, and then emitted from a light exit surface 114 of the integration rod 110.

However, a part of the red light provided by the LED array 130 (such as, a light beam 133) directly enters the integration rod 110 without being reflected by the dichroic mirror 120, and thus, the emitting angle of the light beam 133 at the light exit surface 114 of the integration rod 110 is excessively large. Similarly, a part of the blue light provided by the LED array 140 has a similar problem, and the light beams with an excessively large emitting angle are unable to be utilized effectively. In addition, a part of the blue light (such as, a light beam 143) provided by the LED array 140 is reflected back to the LED array 140 by the dichroic mirror 125 and thus is unable to be used. Likewise, a part of the red light provided by the LED array 130 also has a similar problem. Therefore, the light use efficiency of the conventional illumination system 100 is poor.

FIG. 2 is a schematic view of another conventional illumination system. Referring to FIG. 2, a conventional illumination system 200 comprises an integration rod 210 and a plurality of LEDs 220. The LEDs 220 are directly disposed on the inner wall of the integration rod 210. A light beam 222 emitted by the LEDs 220 is blended within the integration rod 210, and then emitted from a light exit surface 212 of the integration rod 210 for forming an illumination beam.

Accordingly, in the illumination system 200, as the emitting angle of a part of the light beams (such as, light beams 223, 224) at the light exit surface 212 of the integration rod 210 is excessively large, the light beams are unable to be used effectively. Moreover, a light beam with a small emitting angle of the LED 220 has relatively high energy, and the light beams 223, 224 with an excessively large emitting angle when being emitted from the light exit surface 212 are generally those with a small emitting angle of the LED 220, so a relatively high light energy is lost, thereby resulting in a low light use efficiency of the conventional illumination system 200.

### SUMMARY OF THE INVENTION

An objective of the present invention is to provide an illumination system, thereby improving the light use efficiency.

To achieve the above or other objectives, the present invention provides an illumination system, which comprises a light guide element and at least one light source device. The light guide element has a light incident surface and a light exit surface opposite to the light incident surface. The light source device is disposed adjacent to the light incident surface of the light guide element. The light source device comprises a first light combination module disposed adjacent to the light incident surface of the light guide element, a second light combination module disposed adjacent to the first light combination module, at least one first light source disposed adjacent to the first light combination module, and at least one second light source disposed adjacent to the second light combination module and at least one third light source. In addition, the first light combination module has a first top surface adjacent to the light incident surface, a first bottom surface opposite to the first top surface, a plurality of first side surfaces connecting between the first top surface and the first bottom surface, and a first filter film disposed between the first top surface and the first bottom surface. The second light combination module has a second top surface adjacent to the first bottom surface, a second bottom surface opposite to the second top surface, a plurality of second side surfaces connecting between the second top surface and the second bottom surface, and a second filter film disposed between the second top surface and the second bottom surface, a gap is disposed between the second top surface and the first bottom surface. The first light source is suitable for emitting a first color light beam toward the first filter film, and the first filter film is suitable for reflecting the first color light beam to the light guide element. The second light source is suitable for emitting a second color light beam towards the second filter film, the second filter film is suitable for reflecting the second color light beam to the light guide element, and the first filter film is suitable for allowing the second color light to penetrate. The third light source is suitable for emitting a third color light beam to the second light combination module through the second bottom surface. The second filter film and first filter film are suitable for allowing the third color light beam to penetrate and be transmitted to the light guide element.

In the present invention, as a gap is disposed between the first light combination module and the second light combination module, besides the first top surface, the second bottom surface and the first and second side surfaces being used as total reflection surfaces, the first bottom surface and the second top surface are also used as total reflection surfaces, thereby preventing the light beams emitted from the first light source, the second light source and the third light source from having an excessively large emitting angle at the light guide element, so as to improve the light use efficiency of the illumination system.

Other objectives, features and advantages of the present invention will be further understood from the further technology features disclosed by the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional illumination system.

FIG. 2 is a schematic view of another conventional illumination system.

FIG. 3 is a schematic view of an illumination system according to the first embodiment of the present invention.

FIG. 4 is a schematic view of another illumination system according to the first embodiment of the present invention.

FIGS. 5A˜5B are schematic views of yet another two illumination systems according to the first embodiment of the present invention.

FIG. 6 is a schematic view of an illumination system according to the second embodiment of the present invention.

FIG. 7 is a schematic view of another illumination system according to the second embodiment of the present invention.

FIG. 8 is a schematic view of yet another illumination system according to the second embodiment of the present invention.

FIG. 9 is a schematic view of an illumination system according to the third embodiment of the present invention.

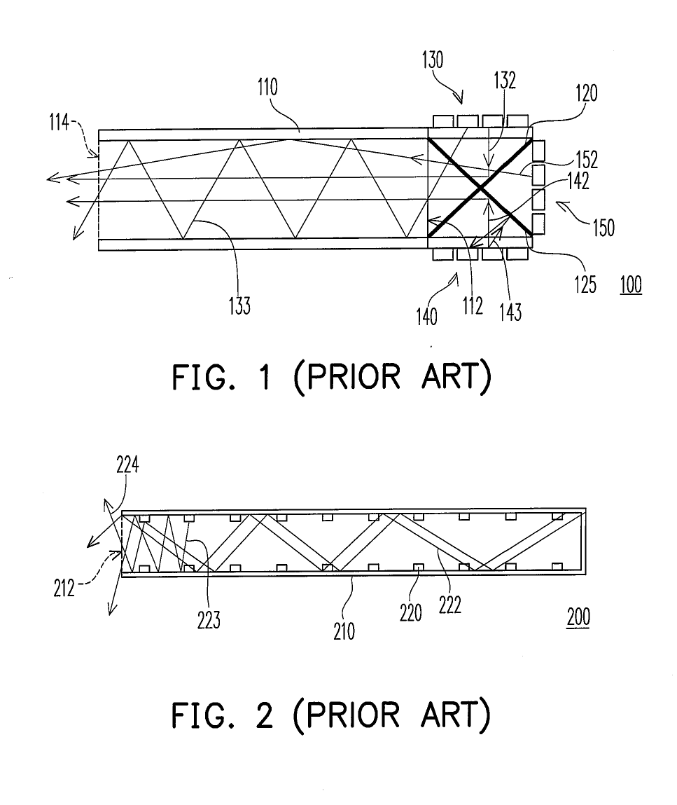

### DESCRIPTION OF THE PREFERRED EMBODIMENTS

### First Embodiment

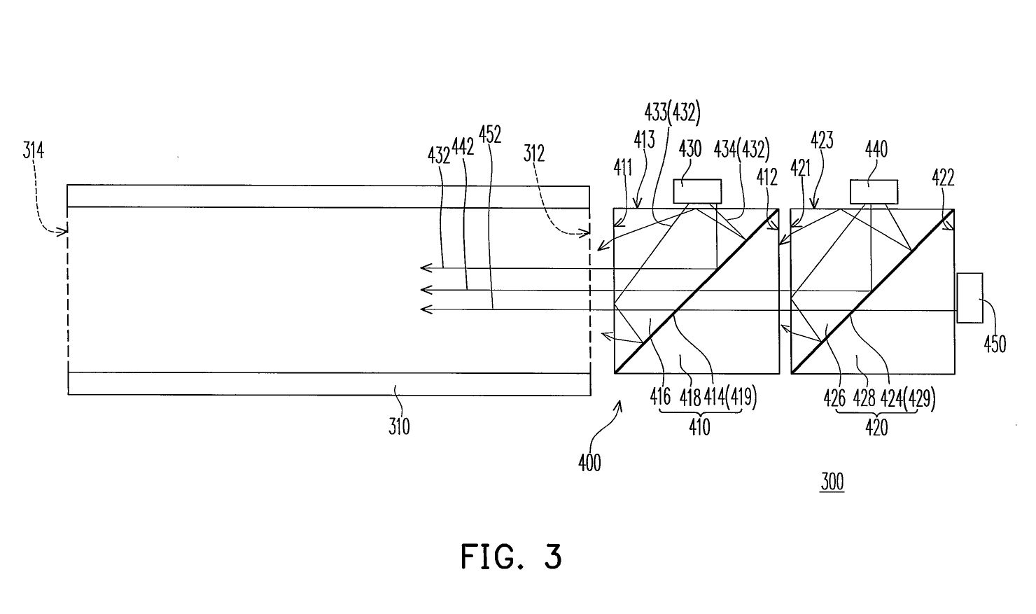

Referring to FIG. 3, an illumination system 300 in this embodiment comprises a light guide element 310 and a light source device 400. The light guide element 310 has a light incident surface 312 and a light exit surface 314 opposite to the light incident surface 312, and the light source device 400 is disposed adjacent to the light incident surface 312 of the light guide element 310. The light source device 400 comprises a first light combination module 410, a second light combination module 420, a first light source 430, a second light source 440 and a third light source 450. The first light combination module 410 is disposed between the light incident surface 312 of the light guide element 310 and the second light combination module 420. The first light source 430 is disposed adjacent the first light combination module 410, and the second light source 440 and the third light source 450 are disposed adjacent to the second light combination module 420. In addition, the first light combination module 410 has a first top surface 411 adjacent to the light incident surface 312, a first bottom surface 412 opposite to the first top surface 411, a plurality of first side surfaces 413 connecting between the first top surface 411 and the first bottom surface 412, and a first filter film 414 disposed between the first top surface 411 and the first bottom surface 412. The second light combination module 420 has a second top surface 421 adjacent to the first bottom surface 412, a second bottom surface 422 opposite to the second top surface 421, a plurality of second side surfaces 423 connecting between the second top surface 421 and the second bottom surface 422, and a second filter film 424 disposed between the second top surface 421 and the second bottom surface 422. A gap is disposed between the second top surface 421 and the first bottom surface 412.

The first light source 430 is suitable for emitting a first color light beam 432 toward the first filter film 414, and the first filter film 414 is suitable for reflecting the first color light beam 432 to the light guide element 310. The second light source 440 is suitable for emitting a second color light beam 442 toward the second filter film 424, and the second filter film 424 is suitable for reflecting the second color light beam 442 to the light guide element 310, and the first filter film 414 is suitable for allowing the second color light beam 442 to penetrate. The third light source 450 is, for example, disposed adjacent to the second bottom surface 422 of the second light combination module 420, and suitable for emitting a third color light beam 452. The third color light beam 452 enters the second light combination module 420 through the second bottom surface 422, and the second filter film 424 and the first filter film 414 are suitable for allowing the third color light beam 452 to penetrate and be transmitted to the light guide element 310.

In this embodiment, the first light source 430, the second light source 440 and the third light source 450 are all, for example, light emitting diodes (LEDs). The first light source 430, the second light source 440 and the third light source 450 are respectively, for example, one of the red LED, the green LED and the blue LED. In addition, the light guide element 310 is, for example, a hollow integration rod, however, other appropriate optical elements (such as, fly eye lens, solid integration rod) is also used as the light guide element. In addition, the first color light beam 432, the second color light beam 442 and the third color light beam 452 are blended within the light guide element 310 and then emitted from the light exit surface 314 for forming an illumination beam.

In view of the above, the first light combination module 410 comprises a first triangular prism 416, a second triangular prism 418 and a first coating layer 419. The second triangular prism 418 forms a cubic prism with the first triangular prism 416. The first top surface 411 is one surface of the first triangular prism 416, and the first bottom surface 412 is one surface of the second triangular prism 418. The first coating layer 419 is disposed at a junction surface between the first triangular prism 416 and the second triangular prism 418, thereby forming the first filter film 414. The second light combination module 420 comprises a third triangular prism 426, a fourth triangular prism 428 and a second coating layer 429. The fourth triangular prism 428 forms a cubic prism with the third triangular prism 426. The second top surface 421 is one surface of the third triangular prism 426, and the second bottom surface 422 is one surface of the fourth triangular prism 428. The second coating layer 429 is disposed at a junction surface between the third triangular prism 426 and the fourth triangular prism 428, thereby forming the second filter film 424.

In the above illumination system 300, the first top surface 411 and the first side surfaces 413 of the first light combination module 410 and the second bottom surface 422 and the second side surfaces 423 of the second light combination module 420 all are used as total reflection surfaces. In addition, since a gap is disposed between the first bottom surface 412 of the first light combination module 410 and the second top surface 421 of the second light combination module 420, the first bottom surface 412 and the second top surface 421 both are also used as total reflection surfaces.

When the first light source 430 emits lights, a part of the first color light beam (such as light beams 433, 434) is reflected between the total reflection surface of the first light-emitting module 410 and the first filter film 414, and not emitted from the first triangular prism 416 until the incident angle for the light beams 433, 434 to enter the first top surface 411 is smaller than the total reflection angle. Therefore, the divergence angle of the first color light beam 432 provided by the first light source 430 after being emitted from the first triangular prism 416 is relatively small, such that the divergence angle of the first color light beam 432 after being emitted from the light exit surface 314 of the light guide element 310 is also relatively small. Similarly, the divergence angle of the second color light beam 442 and the third color light beam 452 provided by the second light source 440 and the third light source 450 after being emitted from the second top surface 421 is relatively small, such that the divergence angle of the second color light beam 442 and the third color light beam 452 after being emitted from the first top surface 411 and the light exit surface 314 of the light guide element 310 is also relatively small. In other words, the divergence angle of the illumination beam after being emitted from the light exit surface 314 of the light guide element 310 is relatively small, such that the illumination system 300 in this embodiment achieves relatively high light use efficiency.

In addition, the bonding between the first triangular prism 416 and the second triangular prism 418 and the bonding between the third triangular prism 426 and the fourth triangular prism 428 both are achieved through an adhesive method for manufacturing an internal total reflection prism (TIR prism). Furthermore, no gap is required between two adhered triangular prisms, thus the manufacturing process is relatively simple, thereby saving the manufacturing cost. In addition, the material of the first triangular prism 416, the second triangular prism 418, the third triangular prism 426 and the fourth triangular prism 428 is glass or plastic. When the first triangular prism 416, the second triangular prism 418, the third triangular prism 426 and the fourth triangular prism 428 are too small to be manufactured by glass, these prisms are able to be directly formed by plastic through injection molding.

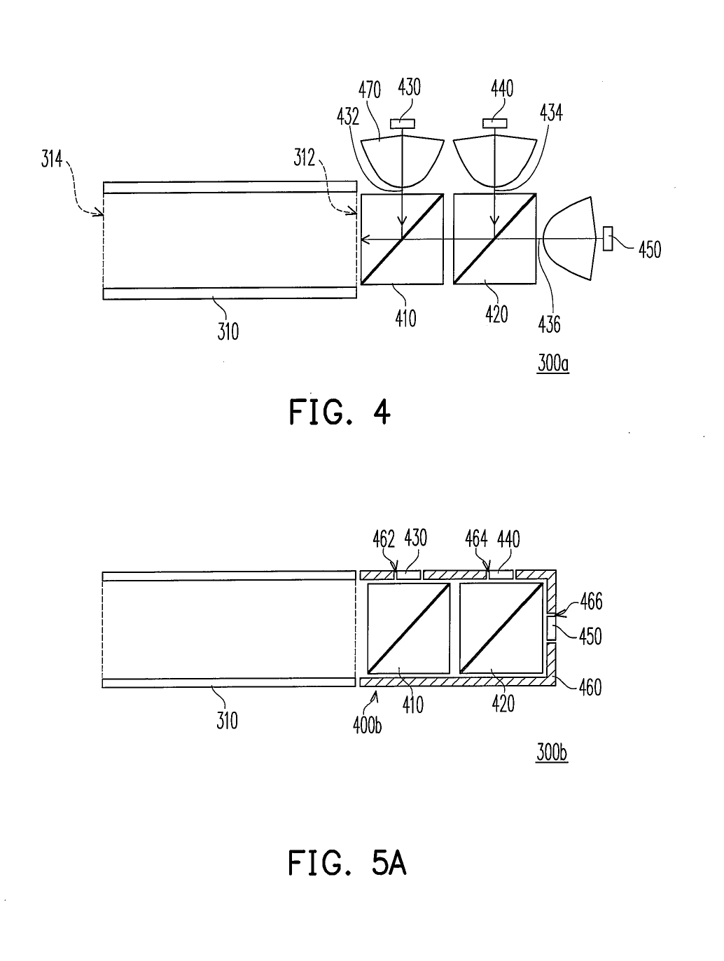

It should be noted that a number of the first light sources 430 is more than one, a number of the second light sources 440 is more than one, and a number of the third light sources 450 is more than one. The first light sources 430, the second light sources 440 and the third light sources 450 are arranged into arrays, thereby further enhancing the intensity of the illumination beam provided by the illumination system 300. In addition, the light source device 400 further comprises a plurality of heat sinks (not shown) respectively connecting to the first light source 430, the second light source 440 and the third light source 450, for dissipating heat of the first light source 430, the second light source 440 and the third light source 450. Furthermore, a collimator 470 is respectively disposed (as shown in FIG. 4) in front of the light exit surfaces of the first light source 430, the second light source 440 and the third light source 450 additionally in order to reduce the divergence angle of the first color light beam 432, the second color light beam 434 and the third color light beam 436.

First, referring to FIG. 5A, the illumination system 300b differs from the illumination system 300 shown in FIG. 3 only in that the light source device 400b of the illumination system 300b further comprises a housing 460 having the first light combination module 410 and the second light combination module 420 disposed therein. The housing 460 has a first opening 462, a second opening 464 and a third opening 466. The first light source 430 is disposed at the first opening 462, the second light source 440 is disposed at the second opening 464, and the third light source 450 is disposed at the third opening 466. Furthermore, the housing 460 and the light guide element 310 are also made integrated (as shown in FIG. 5B).

### Second Embodiment

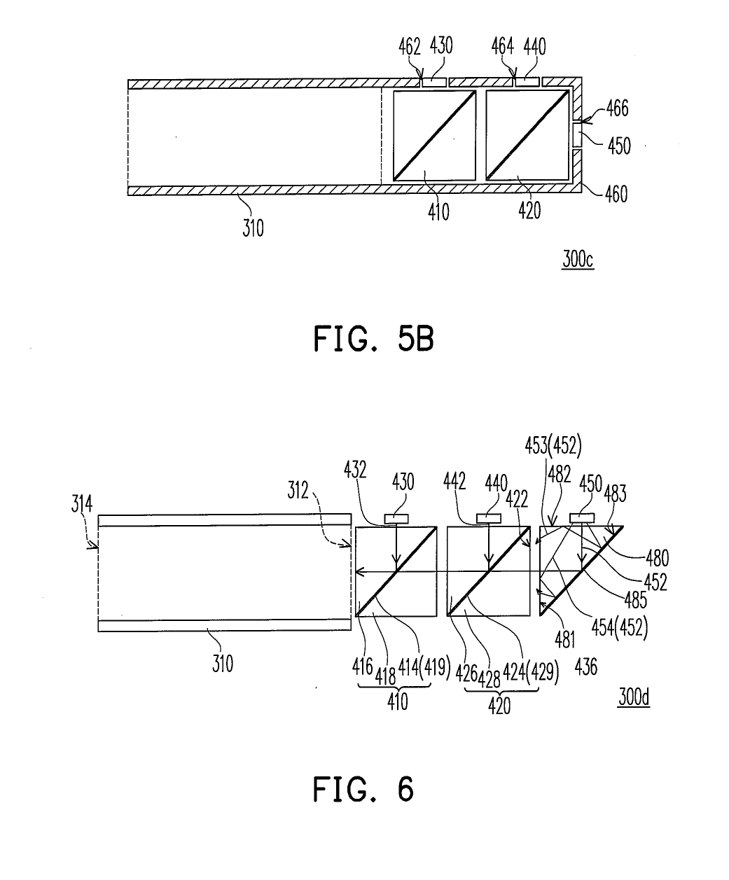

Referring to FIG. 6, the illumination system 300d in this embodiment is similar to the illumination system 300 in the first embodiment (as shown in FIG. 3), except that the light source device 400d of the illumination system 300d further comprises a fifth triangular prism 480 and a third coating layer 485. The fifth triangular prism 480 is disposed adjacent to the second bottom surface 422 of the second light combination module 420. The fifth triangular prism 480 has a first rectangular surface 481, a second rectangular surface 482 and a third rectangular surface 483 connecting between the rectangular surface 481 and the second rectangular surface 482. The first rectangular surface 481 is adjacent to the second bottom surface 422, and a gap is disposed between the first rectangular surface 481 and the second bottom surface 422, such that the second bottom surface 422 and the first rectangular surface 481 both are used as total reflection surfaces. In addition, the third light source 450 is disposed adjacent to the second rectangular surface 482, and the third coating layer 485 is disposed on the third rectangular surface 483. The third light source 450 is suitable for emitting a third color light beam 452 toward the third coating layer 485, and the material of the third coating layer 485 is, for example, silver, which is applicable for reflecting the third color light beam 452 to the second light combination module 420.

Similar to that described in the first embodiment, when the third light source 450 emits light beams, a part of the third color light beam (such as, light beams 453, 454) is reflected between each surface of the fifth triangular prism 480 and the third coating layer 485, and not emitted from the fifth triangular prism 480 until the incident angle for the light beam 453, 454 to enter the first rectangular surface 481 is smaller than the total reflection angle. Therefore, the divergence angle of the third color light beam 452 provided by the third light source 450 after being emitted from the fifth triangular prism 480 is relatively small, such that the divergence angle of the third color light beam 452 after being emitted from the light exit surface 314 of the light guide element 310 is reduced. In addition, since the divergence angle of the first color light beam 432, the second color light beam 442 and the third color light beam 452 after being emitted from the light exit surface 314 of the light guide element 310 is relatively small (that is, the divergence angle for the illumination beam provided by the illumination system 300d is relatively small), the illumination system 300d in this embodiment achieves a preferred light use efficiency.

In the illumination system 300d, a number of the first light sources 430 is more than one, a number of the second light sources 440 is more than one, and a number of the third light sources 450 is more than one. A collimator 470, shown in FIG. 4, is also respectively disposed in front of the light exit surfaces of the first light source 430, the second light source 440 and the third light source 450. In addition, similar to the illumination system 300b, the first light combination module 410, the second light combination module 420 and the fifth triangular prism 480 are disposed within a housing (not shown), and the first light source 430, the second light source 440 and the third light source 450 are disposed at the openings of the housing respectively. Of course, the housing and the light guide element 310 are also made integrated. Furthermore, in the illumination system 300d, a plurality of heat sinks (not shown) is also disposed additionally and used to dissipate heat for the first light source 430, the second light source 440 and the third light source 450.

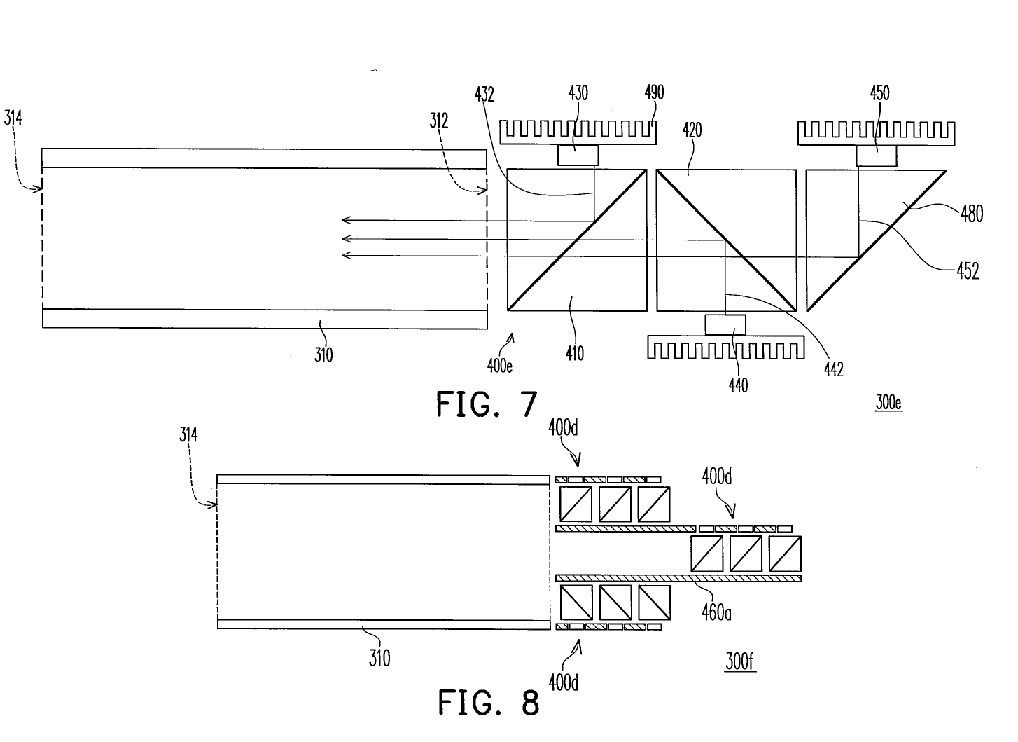

Referring to FIG. 7, different from the light source device 400d (shown in FIG. 6), the first light source 430, the second light source 440 and the third light source 450 are all located at the same side of the second light combination module 420. In the illumination system 300e, the first light source 430 and the third light source 450 of the light source device 400e are located at the same side of the second light combination module 420, and the first light source 430 and the second light source 440 are located at opposite sides of the second light combination module 420 respectively. With this architecture, each of the heat sinks 490 is not interfered with each other, thus the volume of the light source device 400d is further reduced.

Referring to FIG. 8, the illumination system 300f in this embodiment differs from the illumination system 300d in FIG. 6 in that the illumination system 300f comprises a plurality of light source devices 400d disposed, for example, within a housing 460a. The lights provided by each of the light source devices 400d are blended within the light guide element 310, and then emitted from the light exit surface 314 of the light guide element 310 for forming an illumination beam. The illumination system 300f comprises a plurality of light source devices 400d, thereby the intensity of the illumination beam is enhanced.

### Third Embodiment

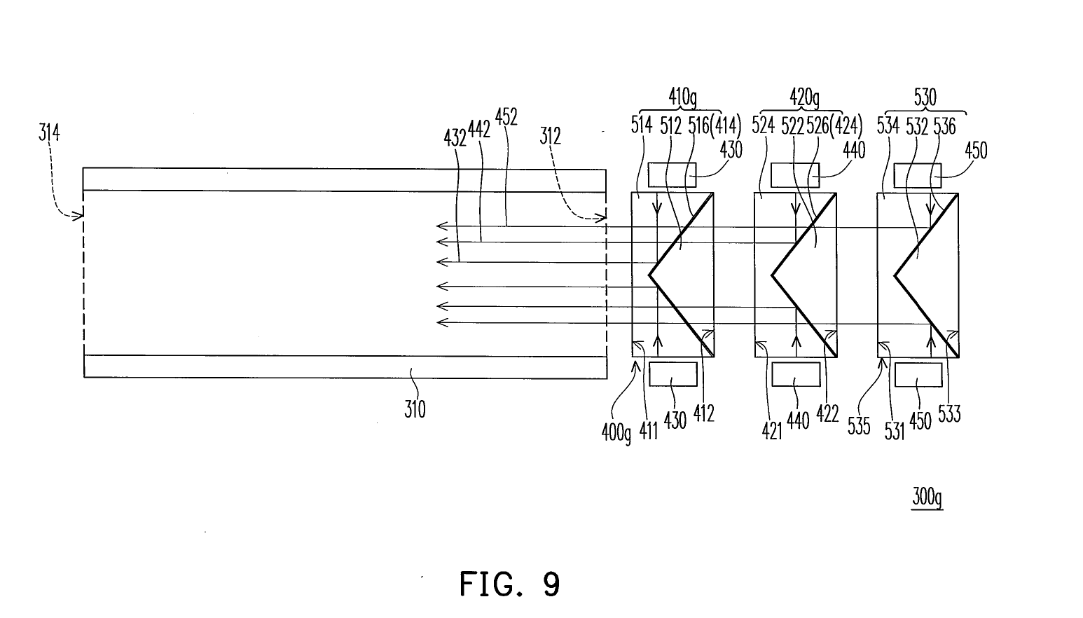

Referring to FIG. 9, the illumination system 300g in this embodiment is similar to the illumination system 300 in FIG. 3, except the following aspects. In the illumination system 300g, the light source device 400g first light sources 430 and second light sources 440. A number of the first light sources 430 is more than one and a number of the second light sources 440 is more than one. The first light sources 430 are disposed at opposite side of the first light combination module 410g, and the second light sources 440 are disposed at opposite side of the second light combination module 420g. Furthermore, the first light combination module 410g comprises a sixth triangular prism 512, a seventh prism 514 and a first coating layer 516. The sixth triangular prism 512 has three rectangular surfaces, and the first bottom surface 412 of the first light combination module 410g is one of the rectangular surfaces. The seventh prism 514 forms a cubic prism by joining with the other two rectangular surfaces of the sixth triangular prism 512 to, and the first light sources 430 are disposed at opposite side of the seventh prism 514. The first coating layer 516 is disposed at the junction surface between the sixth triangular prism 512 and the seventh prism 514 for forming the first filter film 414.

In addition, the second light combination module 420g comprises an eighth triangular prism 522, a ninth prism 524 and a second coating layer 526. The eighth triangular prism 522 has three rectangular surfaces, and the second bottom surface 422 of the second light combination module 420g is one of these rectangular surfaces. The ninth prism 524 forms a cubic prism by joining with the other two rectangular surfaces of the eighth triangular prism 522, and the second light sources 440 are disposed at opposite side of the ninth prism 524. The second coating layer 526 is disposed at the junction surface between the eighth triangular prism 522 and the ninth prism 524 for forming the second filter film 424.

In addition, the light source device 400g further comprises a third light combination module 530 having a third top surface 531 adjacent to the second bottom surface 422, a third bottom surface 533 opposite to the third top surface 531 and a plurality of third side surfaces 535 connecting between the third top surface 531 and the third bottom surface 533. A gap is disposed between the second bottom surface 422 and the third top surface 531, such that both the second bottom surface 422 and the third top surface 531 are able to be used as a total reflection surface. In addition, a plurality of third light sources 450 of the light source device 400g is disposed at opposite side of the third light combination module 530.

In view of the above, the third light combination module 530 comprises a tenth triangular prism 532, an eleventh prism 534 and a third coating layer 536. The tenth triangular prism 532 has three rectangular surfaces, and the third bottom surface 533 is one of the three rectangular surfaces. The eleventh prism 534 forms a cubic prism by joining with the other two rectangular surfaces of the tenth triangular prism 532, and the third light sources 450 are disposed at opposite side of the eleventh prism 534. In addition, the material of the third coating layer 536 is, for example, silver, and the third coating layer 536 is disposed at the junction surface between the tenth triangular prism 532 and the eleventh prism 534. Each of the third light sources 450 is suitable for emitting a third color light beam 452 toward the third coating layer 536, and the third coating layer 536 is suitable for reflecting the third color light beam 452 to the second light combination module 420g.

Similar to the first embodiment, in the illumination system 300g, the first light combination module 410g allows the divergence angle of the first color light beam 432 after being emitted from the first top surface 411 to be reduced, the second light combination module 420g allows the divergence angle of the second color light beam 442 after being emitted from the second top surface 421 to be reduced, and the third light combination module 530 allows the divergence angle of the third color light beam 452 after being emitted from the third top surface 531 to be reduced. Therefore, the divergence angles of the first color light beam 432, the second color light beam 442 and the third color light beam 452 after being emitted from the light exit surface 314 of the light guide element 310 are relatively small. In other words, the divergence angle of the illumination beam after being emitted from the light exit surface 314 of the light guide element 310 is relatively small, thus, the light use efficiency of the illumination system 300g is desirable. Furthermore, a plurality of first light sources 430, second light sources 440 and third light sources 450 are disposed, such that the illumination system 300g provides an illumination beam with higher intensity. It should be noted that, the above seventh prism 514, the ninth prism 524 and the eleventh prism 534 are also composed by two triangular prisms respectively.

To sum up, the illumination system of the present invention at least has the following advantages.

1. Each surface of the first light combination module and that of the second light combination module are able to be used as a total reflection surface, thus avoiding the circumstance that the divergence angles of the lights from the first light source, the second light source and the third light source after being emitted from the light guide element are excessively large, thereby enhancing the light use efficiency of the illumination system.

2. In the light source device of the illumination system, a number of first light source, second light source and third light source is more than one respectively, thus enhancing the intensity of the illumination beam.

3. A number of light source device is more than one, thus providing an illumination beam with higher intensity.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a light guide element, having a light incident surface and a light exit surface opposite to the light incident surface;
at least one light source device, disposed adjacent to the light incident surface of the light guide element, wherein the light source device comprises:
a first light combination module, disposed adjacent to the light incident surface of the light guide element, and having a first top surface adjacent to the light incident surface, a first bottom surface opposite to the first top surface, a plurality of first side surfaces connecting between the first top surface and the first bottom surface, and a first filter film disposed between the first top surface and the first bottom surface;
a second light combination module, disposed adjacent to the first light combination module, and having a second top surface adjacent to the first bottom surface, a second bottom surface opposite to the second top surface, a plurality of second side surfaces connecting between the second top surface and the second bottom surface, and a second filter film disposed between the second top surface and the second bottom surface, wherein a gap is disposed between the second top surface and the first bottom surface;
at least one first light source, disposed adjacent to the first light combination module, wherein the first light source is suitable for emitting a first color light beam toward the first filter film, and the first filter film is suitable for reflecting the first color light beam to the light guide element;
at least one second light source, disposed adjacent to the second light combination module, wherein the second light source is suitable for emitting a second color light beam toward the second filter film, the second filter film is suitable for reflecting the second color light beam to the light guide element, and the first filter film is suitable for allowing the second color light beam to penetrate; and
at least one third light source, disposed adjacent to the second light combination module, wherein the third light source is suitable for emitting a third color light beam to the second light combination module via the second bottom surface, and the second filter film and the first filter film are suitable for allowing the third color light beam to penetrate and be transmitted to the light guide element.

2. The illumination system as claimed in claim 1, wherein the third light source is disposed adjacent to the second bottom surface of the second light combination module.

3. The illumination system as claimed in claim 2, wherein the light source device further comprises a housing with the first light combination module and the second light combination module disposed therein, wherein the housing has a first opening, a second opening and a third opening, the first light source is disposed at the first opening, the second light source is disposed at the second opening, and the third light source is disposed at the third opening.

4. The illumination system as claimed in claim 3, wherein the light guide element comprises an integration rod, and the integration rod and the housing are made integrated.

5. The illumination system as claimed in claim 1, wherein the light guide element is a hollow integration rod, a fly eye lens or a solid integration rod.

6. The illumination system as claimed in claim 1, wherein the first light combination module comprises:
a first triangular prism, wherein the first top surface is a surface of the first triangular prism;
a second triangular prism, forming a cubic prism with the first triangular prism, wherein the first bottom surface is a surface of the second triangular prism; and
a first coating layer, disposed at a junction surface between the first triangular prism and the second triangular prism for forming the first filter film.

7. The illumination system as claimed in claim 1, wherein the second light combination module comprises:
a third triangular prism, wherein the second top surface is a surface of the third triangular prism;
a fourth triangular prism, forming a cubic prism with the third triangular prism, wherein the second bottom surface is a surface of the fourth triangular prism; and
a second coating layer, disposed at a junction surface between the third triangular prism and the fourth triangular prism for forming the second filter film.

8. The illumination system as claimed in claim 1, wherein the light source device further comprises:
a fifth triangular prism, disposed adjacent to the second bottom surface of the second light combination module, and having a first rectangular surface, a second rectangular surface and a third rectangular surface connecting between the first rectangular surface and the second rectangular surface, wherein the first rectangular surface is adjacent to the second bottom surface, a gap is disposed between the first rectangular surface and the second bottom surface, and the third light source is disposed adjacent to the second rectangular surface; and
a third coating layer, disposed on the third rectangular surface, wherein the third light source is suitable for emitting a third color light beam toward the third coating layer, and the third coating layer is suitable for reflecting the third color light beam to the second light combination module.

9. The illumination system as claimed in claim 8, wherein the first light source, the second light source and the third light source are located at the same side of the second light combination module.

10. The illumination system as claimed in claim 8, wherein the first light source and the third light source are located at the same side of the second light combination module, and the first light source and the second light source are located at the opposite side of the second light combination module respectively.

11. The illumination system as claimed in claim 1, wherein a number of the first light sources is more than one and a number of the second light sources is more than one, the first light sources are disposed at opposite side of the first light combination module, and the second light sources are disposed at opposite side of the second light combination module.

12. The illumination system as claimed in claim 11, wherein the first light combination module comprises:
a sixth triangular prism, having three rectangular surfaces, and the first bottom surface being one of the rectangular surfaces;
a seventh prism, forming a cubic prism by joining with the other two rectangular surfaces of the sixth triangular prism, wherein the first light sources are disposed at opposite side of the seventh prism; and
a first coating layer, disposed at a junction surface between the sixth triangular prism and the seventh prism for forming the first filter film.

13. The illumination system as claimed in claim 11, wherein the second light combination module comprises:
an eighth triangular prism, having three rectangular surfaces, and the second bottom surface being one of the rectangular surfaces;
a ninth prism, forming a cubic prism by joining with the other two rectangular surfaces of the eighth triangular prism, wherein the second light sources are disposed at opposite side of the ninth prism; and
a second coating layer, disposed at a junction surface between the eighth triangular prism and the ninth prism for forming the second filter film.

14. The illumination system as claimed in claim 11, wherein the light source device further comprises a third light combination module having a third top surface adjacent to the second bottom surface, a third bottom surface opposite to the third top surface and a plurality of third side surfaces connecting between the third top surface and the third bottom surface, a gap is disposed between the second bottom surface and the third top surface, a plurality of third light sources is disposed at opposite side of the third light combination module, and the third light combination module comprises:
a tenth triangular prism, having three rectangular surfaces and the third bottom surface being one of the rectangular surfaces;
an eleventh prism, forming a cubic prism by joining with the other two rectangular surfaces of the tenth triangular prism, wherein the third light sources are disposed at opposite side of the eleventh prism; and
a third coating layer, disposed at a junction surface between the tenth triangular prism and the eleventh prism, wherein each of the third light sources is suitable for emitting a third color light beam toward the third coating layer, and the third coating layer is suitable for reflecting the third color light beam to the second light combination module.

15. The illumination system as claimed in claim 1, wherein the light source device further comprises a plurality of collimators disposed in front of light exit surfaces of the first light source, the second light source and the third light source.

16. The illumination system as claimed in claim 1, wherein the light source device further comprises a plurality of heat sinks for connecting the first light source, the second light source and the third light source.

17. The illumination system as claimed in claim 1, wherein the first light source, the second light source and the third light source are light emitting diodes (LEDs).
